(19) United States
(12) Patent Application Publication
(10) Pub. No.: US 2026/0359650 A1
(43) Pub. Date: Nov. 12, 2026

(54) GENERATING SYNTHETIC TRAINING DATASETS FROM DIGITAL CONTENT ASSETS UTILIZING A WEIGHTED ROUTER

(71) Applicant: Adobe Inc., San Jose, CA (US)

(72) Inventors: Dewang Sultania, Emeryville, CA (US); Vibha Belavadi, Fremont, CA (US); Tushar Vatsa, San Francisco, CA (US); Suhas Suresha, San Jose, CA (US); Ishita Verma, San Jose, CA (US); Cheng Chen, Guangzhou (CN); Tracy Holloway King, Mountain View, CA (US); Michael Friedrich, Berlin (DE)

(21) Appl. No.: 19/202,664

(22) Filed: May 8, 2025

(51) Int. Cl. G06N 3/09; G06N 3/0475

(52) U.S. Cl. CPC G06N 3/09; G06N 3/0475

(57) ABSTRACT

The present disclosure relates to systems, non-transitory computer-readable media, and methods for generating a synthetic dataset for machine learning model (“MLM”) training from digital content assets utilizing a weighted router. Specifically, the disclosed systems extract, from digital content assets, content metadata. Additionally, the disclosed systems generate, utilizing a weighted router, MLM prompts comprising a first set of prompts of a first prompt type for one or more MLMs from the content metadata according to a first weight of the weighted router and a second set of prompts of a second prompt type for the one or more MLMs from the content metadata according to a second weight of the weighted router. Further, the disclosed systems generate a synthetic dataset comprising labeled prompts for training the one or more MLMs by generating, utilizing one or more large language models, labels indicating function classifications for the MLM prompts.

### BACKGROUND

Recent years have seen significant improvements in artificial intelligence models that learn patterns from data and make predictions, decisions, or generate content based on that learning. However, significant limitations exist relative to training and evaluating models for real-world applications. For example, one major obstacle is the reliance on real user data, which is often unavailable due to privacy concerns or data sparsity. This lack of accessible data results in the necessity of generating synthetic data to train models. However, creating diverse and complex model training data that accurately replicate the distribution of real-world user interactions remains a persistent problem. Indeed, although some conventional systems generate synthetic model training data, they have a number of technical deficiencies with regard to flexibility and accuracy.

### SUMMARY

Embodiments of the present disclosure provide benefits and/or solve one or more of the foregoing or other problems in the art with systems, non-transitory computer-readable media, and methods for generating a synthetic dataset for machine learning model training from digital content assets utilizing a weighted router. In particular, the disclosed systems extract metadata and relationship information from digital content assets (e.g., templates, images, videos, etc.) and knowledge graphs. Further, in some embodiments, the disclosed systems utilize a weighted router to route the extracted metadata and relationship information to prompt templates designed for generating varying types of machine learning model prompts. In these or other embodiments, the disclosed systems generate a synthetic dataset including machine learning model prompts using the prompt templates and the extracted metadata and relationship information. Additionally, in some implementations, the disclosed systems utilize large language models to generate the synthetic dataset by generating labels for the prompts to indicate various characteristics of the prompts (e.g., whether the prompts are related to generation tasks or search tasks).

Additional features and advantages of one or more embodiments of the present disclosure are outlined in the description which follows, and in part are determined from the description, or are learned by the practice of such example embodiments.

### BRIEF DESCRIPTION OF THE DRAWINGS

The detailed description provides one or more embodiments with additional specificity and detail through the use of the accompanying drawings, as briefly described below.

FIG. 1 illustrates an example system environment in which a dataset generation system operates in accordance with one or more embodiments.

FIG. 2 illustrates an overview diagram of the dataset generation system generating a synthetic dataset from digital content assets utilizing a weighted router in accordance with one or more embodiments.

FIG. 3 illustrates a diagram of the dataset generation system extracting information from digital content assets in accordance with one or more embodiments.

FIG. 4 illustrates a diagram of the dataset generation system generating machine learning model prompts utilizing a weighted router in accordance with one or more embodiments.

FIG. 5 illustrates a diagram of the dataset generation system utilizing large language models to generate labeled machine learning model prompts of a synthetic dataset in accordance with one or more embodiments.

FIG. 6 illustrates a graph indicating content type counts of a synthetic dataset achieved by the dataset generation system compared with example prior art content type counts in accordance with one or more embodiments.

FIG. 7 illustrates a graph indicating keyword positions in a synthetic dataset achieved by the dataset generation system compared with example prior art keyword positions in accordance with one or more embodiments.

FIG. 8 illustrates an example schematic diagram of the dataset generation system in accordance with one or more embodiments.

FIG. 9 illustrates a flowchart of an example series of acts for generating a synthetic dataset of labeled prompts from extracted digital content asset information utilizing a weighted router in accordance with one or more embodiments.

FIG. 10 illustrates a block diagram of an example computing device for implementing one or more embodiments of the present disclosure.

### DETAILED DESCRIPTION

This disclosure describes one or more embodiments of a dataset generation system that generates a synthetic dataset of labeled training prompts from digital content assets utilizing a weighted router. In particular, the dataset generation system extracts metadata from digital content assets and relationship information of the digital content assets from knowledge graphs. Moreover, in one or more embodiments, the dataset generation system utilizes a weighted router to route the metadata, relationship information, and visual content of the digital content assets to prompt templates to generate varying types of machine learning model prompts. Additionally, in one or more implementations, the dataset generation system labels the prompts of the synthetic dataset utilizing large language models and generates a synthetic dataset including the labeled machine learning model prompts.

As mentioned above, in some embodiments, the dataset generation system extracts metadata from digital content assets (e.g., templates, images, videos) and relationship information of the digital content assets from knowledge graphs for generating machine learning model prompts. Specifically, the dataset generation system extracts metadata from digital content assets to determine real-world content for a specific domain without utilizing private user data. Furthermore, in some implementations, the dataset generation system accesses knowledge graphs associated with the digital content assets and extracts relationship information representing real-world content organization and classification information of the metadata.

As noted above, in one or more embodiments, the dataset generation system utilizes a weighted router to route the metadata, relationship information, and visual content of the digital content assets to prompt templates to generate varying types of machine learning model prompts. In particular, the dataset generation system utilizes the weighted router to distribute the metadata, relationship information, and/or visual content across different types of prompt templates corresponding to different machine-learning tasks such as content generation tasks or search tasks. In these or other embodiments, the dataset generation system generates a variety of machine learning model prompts that have similar content type distributions and keyword diversity to real-world training data.

As mentioned previously, in one or more implementations, the dataset generation system labels the prompts of the synthetic dataset utilizing large language models and generates a synthetic dataset including the labeled machine learning model prompts. Specifically, the dataset generation system trains large language models (e.g., text-to-text large language models and/or vision-to-text large language models) to label the machine learning model prompts to indicate function classifications, content types, etc., of the machine learning model prompts. Additionally, in some embodiments, the dataset generation system combines the generated labels with the corresponding machine learning model prompts to generate a synthetic training dataset for training machine learning models.

Although some conventional systems generate synthetic model training data, such systems have a number of problems in relation to flexibility of operation and accuracy. In particular, conventional systems demonstrate operational inflexibility by generating synthetic training data that lack the varied and context-rich model inputs that users typically provide, resulting in models with suboptimal performance after fine-tuning. For instance, conventional systems such as function calling models perform poorly in specialized domains by failing to maintain real-world query distributions when generating synthetic data. To illustrate, conventional synthetic data generation systems often struggle to replicate real-world data diversity, resulting in imbalanced datasets where certain content types are overrepresented. Additionally, such conventional systems lack domain-specific knowledge integration when generating synthetic data.

Furthermore, conventional systems often inaccurately generate synthetic training data, in addition to their inflexibility of operation. In particular, conventional systems often mislabel generated synthetic data such as prompts for artificial intelligence models. For example, conventional systems frequently demonstrate poor function classification accuracy. In addition, conventional systems also incorrectly generate data by selecting incorrect application programming interface (“API”) parameters. Erroneously labeled training data and incorrectly selected parameters lead to poorly trained models that make mistakes in interpreting queries and generating responses to queries, particularly when handling queries in multiple domains or with multiple modalities and/or in unseen domains.

As suggested by the foregoing, embodiments of the dataset generation system provide a variety of improvements relative to conventional systems. For example, by utilizing a weighted router and domain resources such as digital content asset metadata and relationship information to generate a synthetic dataset, the dataset generation system improves flexibility relative to conventional systems. Specifically, the dataset generation system flexibly routes the content metadata and relationship information of digital content assets to generate synthetic data that matches observed real-world distributions. Indeed, in some implementations, the dataset generation system utilizes the weighted router to route this information to specialized prompt templates to generate the synthetic dataset. Accordingly, the dataset generation system generates a balanced and diverse distribution of synthetic data (e.g., including machine learning model prompts) across content types (e.g., image, background, video, audio, template, etc.). Further, the dataset generation system reduces keyword position bias (e.g., for content type keywords within user queries).

Moreover, by utilizing the weighted router and domain resources as just described, the dataset generation system improves accuracy relative to conventional systems. In particular, the dataset generation system generates synthetic data with improvements in both function classification accuracy and API parameter selection. Indeed, machine learning models fine-tuned with the synthetic datasets generated by the dataset generation system consistently outperform models trained using conventionally generated synthetic training data. For instance, machine learning models trained on the balanced and diverse synthetic data generated by the dataset generation system are less likely to overfit to dominant data types and learn meaningful features that apply across a broader spectrum of data types. Additionally, because of the reduced keyword position bias of the synthetic data, machine learning models trained on the synthetic data better understand semantic context and relationships between words. Indeed, these machine learning models generate more accurate and flexible responses across a wider variety of prompt formulations.

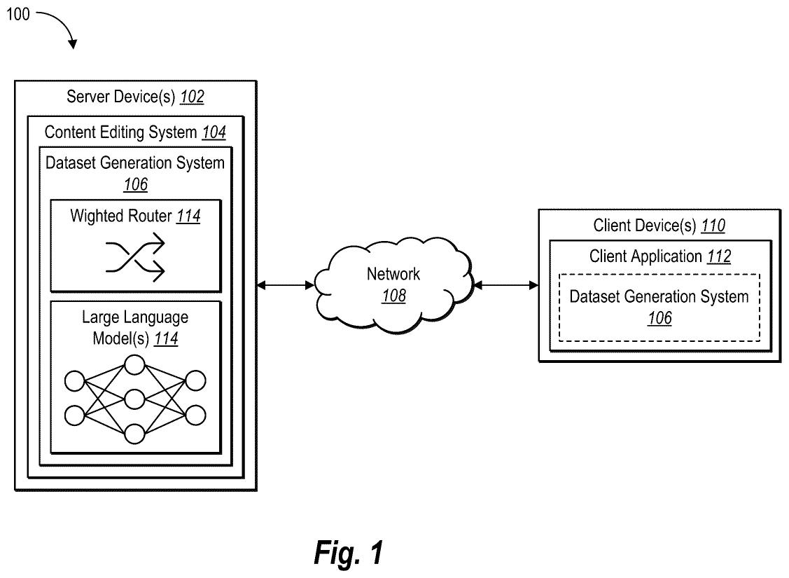

Additional detail regarding the dataset generation system will now be provided with reference to the figures. For example, FIG. 1 illustrates a schematic diagram of a system environment 100 in which a dataset generation system 106 operates. As illustrated in FIG. 1, the system environment 100 includes a server device(s) 102, a network 108, and a client device(s) 110. Although the system environment 100 of FIG. 1 is depicted as having a particular number of components, the system environment 100 is capable of having any number of additional or alternative components (e.g., any number of server devices, client devices, or other components in communication with the dataset generation system 106 via the network 108). Similarly, although FIG. 1 illustrates a particular arrangement of the server device(s) 102, the network 108, and the client device(s) 110, various additional arrangements are possible.

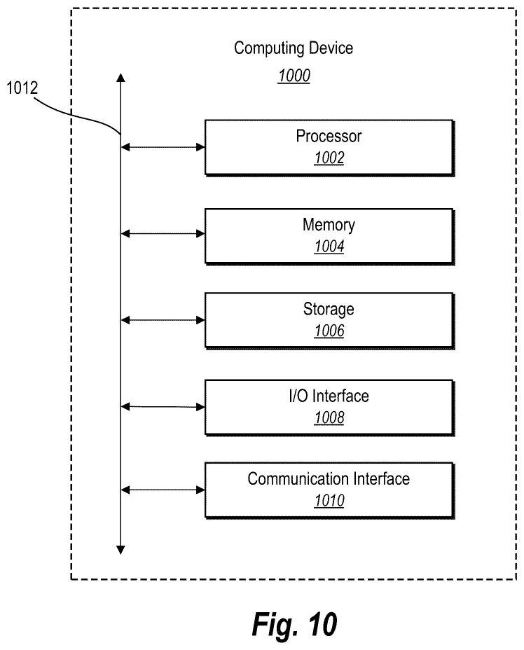

The server device(s) 102, the network 108, and the client device(s) 110 are communicatively coupled with each other either directly or indirectly (e.g., through the network 108 discussed in greater detail below in relation to FIG. 10). Moreover, the server device(s) 102 and the client device(s) 110 include one or more of a variety of computing devices (including one or more computing devices as discussed in greater detail with relation to FIG. 10).

As mentioned above, the system environment 100 includes the server device(s) 102. In one or more embodiments, the server device(s) 102 generates, stores, receives, and/or transmits data including notifications, models, and digital images. In one or more embodiments, the server device(s) 102 comprises a data server. In some implementations, the server device(s) 102 comprises a communication server, a content editing server, or a web-hosting server.

As shown, the server device(s) 102 includes a content editing system 104. In one or more embodiments, the content editing system 104 provides functionality by which a client device (e.g., the client device(s) 110) views, generates, stores, and/or edits digital content including digital content assets and machine learning model training data. For example, in some instances, a client device sends digital content assets to the content editing system 104 hosted on the server device(s) 102 via the network 108. The content editing system 104 then provides options usable by the client device to generate machine learning model training data from the digital content assets, store machine learning model training data, and subsequently search for, access, and view the machine learning model training data. To illustrate, the content editing system 104 provides one or more options that are usable by the client device to generating machine learning model training data and train one or more large language models using the machine learning model training data.

As further shown, the server device(s) 102 also include the dataset generation system 106 implementing a weighted router 114 and large language models (e.g., the large language model(s) 116) to generating content such as labeled machine learning model training data therefrom in the content editing system 104. In one or more embodiments, the dataset generation system 106 generates machine learning model training data such as machine learning model prompts utilizing the weighted router 114. Further, as will be explained below, the dataset generation system 106 uses the machine learning model prompts generated via the weighted router 114 with a large language model(s) 116 to generate labels for machine learning model prompts. Additionally, the dataset generation system 106 generates a synthetic dataset including the machine learning model prompts and corresponding labels for training machine learning models.

As illustrated in FIG. 1, the dataset generation system 106 includes a weighted router 114. Indeed, in one or more embodiments, the dataset generation system 106 accesses the weighted router 114 to modify the weights thereof or implements the weighted router 114 to route information extracted from digital content assets to different destinations (e.g., different prompt templates).

In one or more implementations, a weighted router includes a model used to direct inputs to different destinations. Specifically, a weighted router operates by utilizing weights that determine how often each destination, such as prompt template, receives data. For example, a weighted router might prioritize certain templates by including higher weights corresponding to the certain templates. In some examples, the weighted router distributes data evenly across all prompt templates by using balanced weights for each prompt template.

As illustrated in FIG. 1, the dataset generation system 106 includes the large language model(s) 116. Indeed, in these or other embodiments, the dataset generation system 106 accesses the large language model(s) 116 to modify parameters thereof or implements the large language model(s) 116 to generate outputs such as labels for machine learning model prompts. In some cases, the large language model(s) 116 are external to the dataset generation system 106, but the dataset generation system 106 nevertheless accesses and utilizes the large language model(s) 116 via one or more plugins, APIs, or other network-based access protocols.

In some embodiments, a large language model includes or refers to a specialized type of machine learning model, and more particularly, a specialized type of neural network. For example, a machine learning model includes a computer algorithm or a collection of computer algorithms that automatically improve for a particular task through iterative outputs or predictions based on use of data. To illustrate, a machine learning model utilizes one or more learning techniques to improve in accuracy and/or effectiveness. Example machine learning models include various types of neural networks, decision trees, support vector machines, linear regression models, and Bayesian networks.

Along these lines, a neural network refers to a machine learning model that is trained and/or tuned based on inputs to generate digital content such as text and images, and to determine classifications, scores, or approximate unknown functions. For example, a neural network includes a model of interconnected artificial neurons (e.g., organized in layers) that communicate and learn to approximate complex functions and generate outputs (e.g., information flow patterns) based on a plurality of inputs provided to the neural network. In some cases, a neural network refers to a computer process that implements deep learning techniques to model high-level abstractions in data. In some embodiments, a neural network includes various layers a long short-term memory (LSTM) layer or other recurrent neural network layer and a separate dense layer.

In one or more implementations, the large language model(s) 116 includes an artificial intelligence model capable of processing and generating natural language text or other language-based prompts using language understanding. In particular, large language models are trained on large amounts of data to learn patterns and rules of language. As such, a large language model post-training is capable of generating output predictions such as predicted text (e.g., left-to-right predicted text). Further, in some embodiments, a large language model includes or refers to one or more decoder-only large language models capable of processing language-based prompts (e.g., natural language text) to generate outputs such as labels for machine learning model prompts. In particular, a large language model includes parameters trained (e.g., via deep learning) on large amounts of data to learn patterns and rules of language for summarizing and/or generating text.

In one or more embodiments, the client device(s) 110 includes a computing device that accesses, edits, segments, modifies, stores, and/or provides, for display, digital content such as digital content assets and/or machine learning model training data (e.g., synthetic data including labeled machine learning model prompts). For example, in some embodiments, the client device(s) 110 includes a smartphone, a tablet, a desktop computer, a laptop computer, a head-mounted-display device, or another electronic device, including those explained below with reference to FIG. 10. In some instances, the client device(s) 110 includes one or more applications (e.g., a client application 112) that access, edit, segment, modify, store, and/or provide, for display, digital content assets and/or machine learning model training data. For example, in one or more embodiments, the client application 112 includes a software application installed on the client device(s) 110. Additionally, or alternatively, the client application 112 includes a web browser or other application that accesses a software application hosted on the server device(s) 102 (and supported by the content editing system 104).

Additionally, as shown in FIG. 1, the system environment 100 includes the network 108. The network 108 enables communication between components of the system environment 100. In one or more embodiments, the network 108 may include the Internet or World Wide Web. Additionally, the network 108 optionally include various types of networks that use various communication technology and protocols, such as a corporate intranet, a virtual private network (VPN), a local area network (LAN), a wireless local network (WLAN), a cellular network, a wide area network (WAN), a metropolitan area network (MAN), or a combination of two or more such networks. Indeed, the server device(s) 102 and the client device(s) 110 communicates via the network using one or more communication platforms and technologies suitable for transporting data and/or communication signals, including any known communication technologies, devices, media, and protocols supportive of data communications, examples of which are described with reference to FIG. 10.

To provide an example implementation, in some embodiments, the dataset generation system 106 on the server device(s) 102 supports the dataset generation system 106 on the client device(s) 110. For instance, in some cases, the dataset generation system 106 on the server device(s) 102 generates or learns parameters for the large language model(s) 116. The dataset generation system 106 then, via the server device(s) 102, provides the large language model(s) 116 to the client device(s) 110. In other words, the client device(s) 110 obtains (e.g., downloads) the large language model(s) 116 from the server device(s) 102. Once downloaded, the dataset generation system 106 on the client device(s) 110 uses the large language model(s) 116 to train and or implement the large language models to generate and implement outputs labels for machine learning model prompts independent of the server device(s) 102. In some implementations, the dataset generation system 106 generates or learns parameters for the large language model(s) 116 on the client device(s) 110.

In alternative implementations, the dataset generation system 106 includes a web hosting application that allows the client device(s) 110 to interact with content and services hosted on the server device(s) 102. To illustrate, in one or more implementations, the client device(s) 110 accesses a software application supported by the server device(s) 102. The client device(s) 110 provides input to the server device(s) 102, such as a training data and/or digital documents for use as input and/or for incorporation with the output of large language model. In response, the dataset generation system 106 on the server device(s) 102 generates modified parameters of a large language model or generated labels for machine learning model prompts using the large language model with the modified parameters. The server device(s) 102 then provides the generated labels to the client device(s) 110 for display and/or further processing.

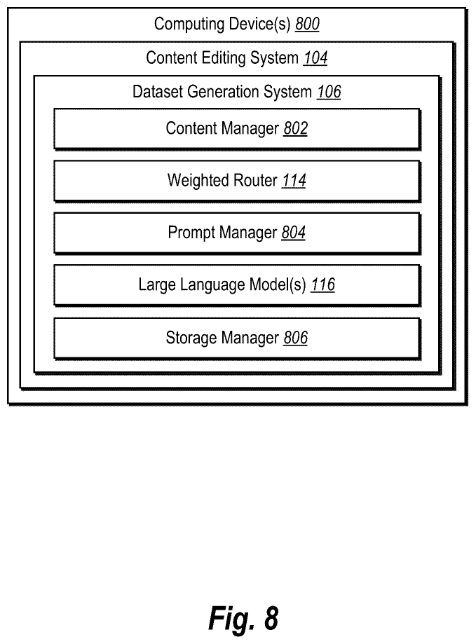

Although FIG. 1 illustrates the dataset generation system 106 implemented with regard to the server device(s) 102, different components of the dataset generation system 106 are able to be implemented by a variety of devices within the system environment 100. For example, in some instances, a different computing device (e.g., the client device(s) 110) or a separate server from the server device(s) 102 implements one or more (or all) components of the dataset generation system 106. Indeed, as shown in FIG. 1, the client device(s) 110 includes the dataset generation system 106. Example components of the dataset generation system 106 will be described below with regard to FIG. 8.

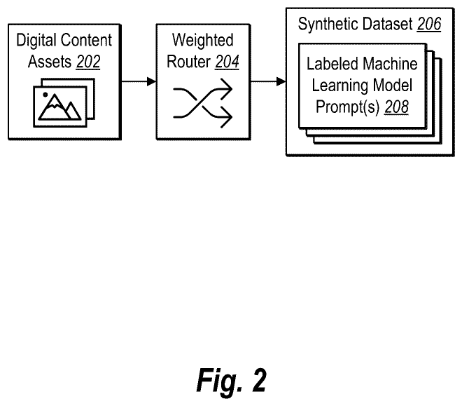

As noted previously, in some embodiments, the dataset generation system 106 generates a synthetic dataset of labeled training prompts from digital content assets utilizing a weighted router. For example, in some implementations, the dataset generation system 106 extracts information from the digital content assets from which to generate the synthetic dataset. FIG. 2 illustrates an overview diagram of the dataset generation system 106 generating a synthetic dataset from digital content assets utilizing a weighted router in accordance with one or more embodiments.

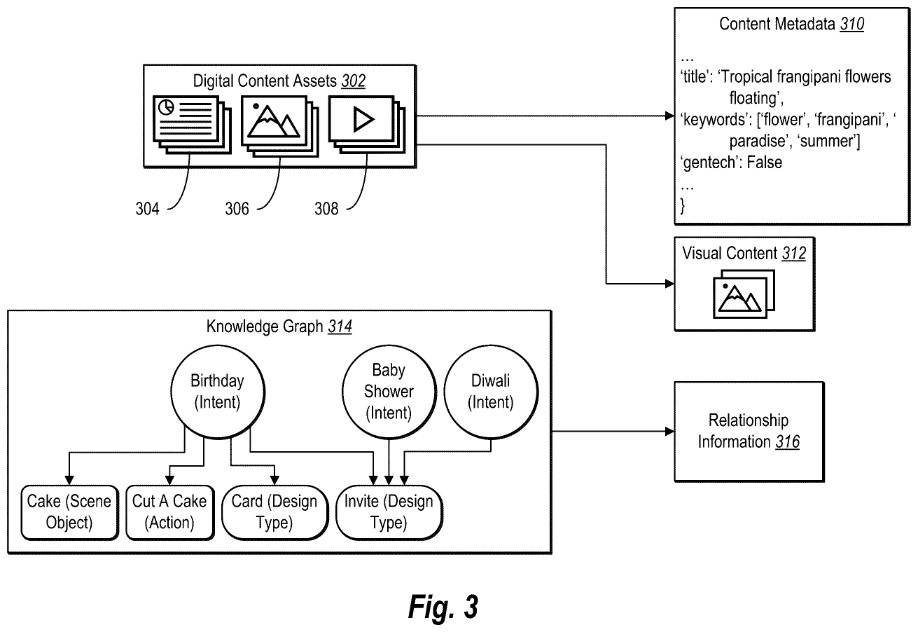

As illustrated in FIG. 2, in one or more embodiments, the dataset generation system 106 generates a synthetic dataset 206 from digital content assets 202. Specifically, the dataset generation system 106 extracts information from the digital content assets 202 from which to generate the synthetic dataset 206. For example, the dataset generation system 106 extracts information such as content metadata from the digital content assets 202 and relationship information of the digital content assets 202 from a knowledge graph. Additional detail regarding extracting the information from the digital content assets is provided with respect to FIG. 3.

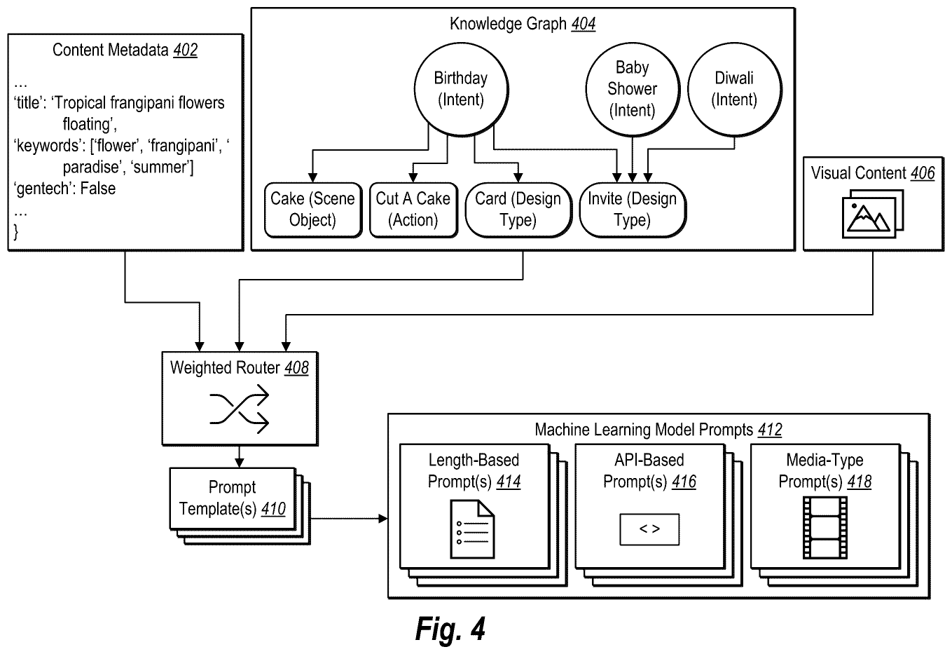

As further illustrated in FIG. 2, in one or more implementations, the dataset generation system 106 utilizes a weighted router 204 (e.g., the weighted router 114 of FIG. 1) to generate the synthetic dataset 206. In particular, the dataset generation system 106 utilizes the weighted router 204 to route the extracted information from the digital content assets 202 to prompt templates. For example, the dataset generation system 106 routes portions of the extracted information to different types of prompt templates to generate machine learning model prompts. Additional detail regarding utilizing the weighted router 204 to generate the machine learning model prompts is provided with respect to FIG. 4.

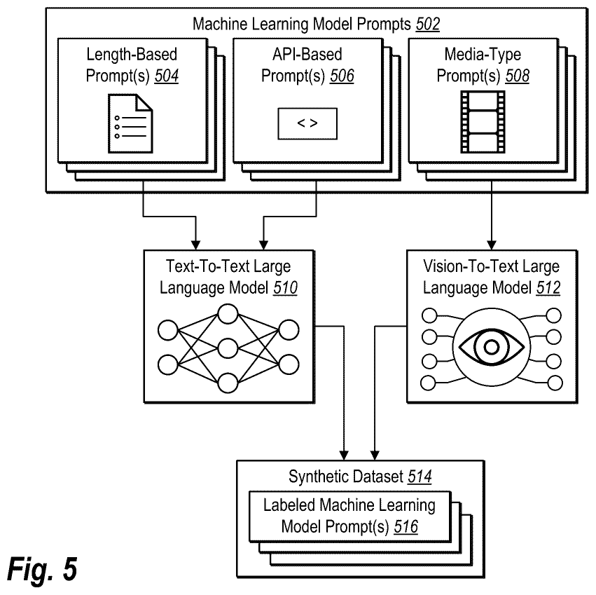

As additionally shown in FIG. 2, in some embodiments, the dataset generation system 106 generates the synthetic dataset 206 to include labeled machine learning model prompts 208. Specifically, the dataset generation system 106 generates labels for the machine learning model prompts as part of generating the synthetic dataset 206. For instance, the dataset generation system 106 utilizes large language models to generate labels indicating certain characteristics (e.g., function, content type, sub-prompt) of the machine learning model prompts. In these or other embodiments, the dataset generation system 106 generates the synthetic dataset by labeling the machine learning model prompts with the labels. Additional detail regarding generating the synthetic dataset 206 by generating labels for the machine learning model prompts is provided with respect to FIG. 5.

As previously mentioned, in some implementations, the dataset generation system 106 extracts information from digital content assets. FIG. 3 illustrates a diagram of the dataset generation system 106 extracting information from digital content assets in accordance with one or more embodiments.

As shown in FIG. 3, in one or more embodiments, the dataset generation system 106 accesses digital content assets 302 (e.g., the digital content assets 202 of FIG. 2) from which to extract information. In particular, the dataset generation system 106 accesses the digital content assets 302, which include templates 304, digital images 306, digital videos 308, backgrounds, or other digital files or digital content of a domain. For example, the dataset generation system 106 accesses the digital content assets 302 of a domain to extract information from the digital content assets 302.

As further illustrated in FIG. 3, in one or more implementations, the dataset generation system 106 extracts information such as content metadata 310 from the digital content assets 302. Specifically, the dataset generation system 106 extracts content metadata 310 comprising characteristics of the digital content assets 302. For example, the dataset generation system 106 extracts characteristics of each digital content asset such as a title, locale, aspect ratio, click through rate, keywords or tags associated with the digital content asset, information about the origin of the digital content asset such as whether it was generated by AI, etc.

As also depicted in FIG. 3, in some embodiments, the dataset generation system 106 extracts visual content 312 from the digital content assets 302. In particular, the dataset generation system 106 extracts visual content such as digital images, digital videos, visual representations of non-image content, or other visuals from (or based on) the digital content assets 302. In some implementations, the dataset generation system 106 compiles the digital content assets 302 that include visual content (e.g., digital images, digital videos, etc.) into a repository comprising the visual content 312.

As further illustrated in FIG. 3, in one or more embodiments, the dataset generation system 106 extracts information from knowledge graphs 314 associated with the digital content assets 302. Specifically, the dataset generation system 106 extracts from the knowledge graphs 314 relationship information associated with the characteristics of the digital content assets 302. For instance, the dataset generation system 106 extracts relationship information providing contextually relevant information that reflects real-world content organization and classifications of the content metadata 310.

In one or more implementations, the knowledge graph 314 consists of interconnected nodes representing entities of the digital content assets 302 such as user intents, design types, scene objects, associated actions, etc. Example user intents of the knowledge graph 314 include “birthday,” “Diwali,” “baby shower,” etc.). Furthermore, example design types include “card,” “invite,” etc. Additionally, example scene objects include “cake” and example associated actions include “cut a cake.” In some embodiments, the edges between the nodes of the knowledge graph 314 represent relationships between the nodes reflecting historical and/or semantic relationships between the different entities.

As previously noted, in some implementations, the dataset generation system 106 generates machine learning model prompts utilizing a weighted router. Indeed, in one or more embodiments, the dataset generation system 106 utilizes the weighted router to route information extracted from digital content assets to prompt templates. FIG. 4 illustrates a diagram of the dataset generation system 106 generating machine learning model prompts utilizing a weighted router in accordance with one or more embodiments.

As portrayed in FIG. 4, in one or more implementations, the dataset generation system 106 utilizes information extracted from digital content assets to generate machine learning model prompts 412. In particular, the dataset generation system 106 utilizes extracted digital content asset information such as content metadata 402 (e.g., the content metadata 310 of FIG. 3), relationship information 404 (e.g., the relationship information 316), and visual content 406 (e.g., the visual content 312).

As additionally shown in FIG. 4, in some embodiments, the dataset generation system 106 utilizes a weighted router 408 (e.g., the weighted router 114) to route the content metadata 402, relationship information 404, and the visual content 406 to prompt templates 410. Specifically, the dataset generation system 106 utilizes the weighted router to route subsets of the content metadata 402, relationship information 404, and the visual content 406 to different prompt template types to generate different machine learning model prompt types. For example, the dataset generation system 106 utilizes weights of the weighted router to route the content metadata 402, relationship information 404, and the visual content 406 to the different prompt template types. In one or more embodiments, the dataset generation system 106 determines the weights based on historical data, heuristics, selected parameters, or other criteria, resulting in generated prompts that conform to real-world data distributions. In other embodiments, the dataset generation system 106 determines the weights to generate prompts that conform to other distributions, such as weighting toward a particular prompt type for a particular type of model, etc.

To illustrate, the dataset generation system 106 routes a first subset of the content metadata 402, relationship information 404, and the visual content 406 to one or more templates of a first type based on a first weight of the weighted router 408. Further, in this example, the dataset generation system 106 routes a second subset of the content metadata 402, relationship information 404, and the visual content 406 to one or more templates of a second type based on a second weight of the weighted router 408. In some implementations, the dataset generation system 106 routes subsets of the content metadata 402, relationship information 404, and the visual content 406 to as many prompt templates and/or prompt template types as are determined by the dataset generation system 106. For example, in one or more embodiments, the dataset generation system 106 defines the number and types of the prompt templates and determines weights for each.

In one or more implementations, a prompt template includes a template for arranging or modifying information into a machine learning model prompt 412. In particular, a prompt template includes a predefined structure or format which the dataset generation system 106 utilizes with the content metadata 402, relationship information 404, and/or the visual content 406 to generate the machine learning model prompts 412. Moreover, the dataset generation system 106 utilizes various prompt template types corresponding to the various types of machine learning model prompts 412 that the dataset generation system 106 generates.

In some embodiments, the dataset generation system 106 utilizes prompt templates 410 including text prompt templates. In some implementations, text prompt templates include length-based prompt templates, API-based prompt templates, etc. Furthermore, in one or more embodiments, the dataset generation system 106 utilizes various different length-based prompt templates depending upon the desired length of the machine learning model prompts 412. For example, the dataset generation system 106 utilizes length-based prompt templates for any desired length of template (e.g., short, medium, long).

In one or more implementations, the length-based prompt templates include a length condition defining the length of the length-based prompt templates. For example, a length-based prompt template includes a length condition directing the dataset generation system 106 to generate a machine learning model prompt to include a given number of words (e.g., two, three, four, five, etc.). Additionally, in some embodiments, the dataset generation system 106 generates the length-based prompts 414 as search queries or content generation queries.

Further, in some implementations, the dataset generation system 106 utilizes various different API-based prompt templates. For instance, the dataset generation system 106 utilizes API-based prompt templates for utilizing different APIs or combinations thereof. In one or more embodiments, the API-based prompt templates include a search API-based template for prompts to search operations or generative API-based template for prompts to perform content generation operations.

Moreover, in one or more implementations, the dataset generation system 106 utilizes prompt templates 410 including media-type templates. Specifically, the dataset generation system 106 utilizes media-type templates for generating machine learning model prompts 412 that include visual content (e.g., the visual content 406). In some embodiments, the media-type prompt templates include a search media-type prompt template and/or a generative media-type prompt template.

As further illustrated in FIG. 4, in some implementations, the dataset generation system 106 generates the machine learning model prompts 412 including text prompts such as length-based prompts 414 and/or API-based prompts 416. In particular, the dataset generation system 106 generates the length-based prompts 414 which have the same or different prompt lengths. For example, the dataset generation system 106 combines the content metadata 402 and/or relationship information 404 with a prompt template 410 (e.g., a length-based prompt template) to generate the length-based prompts 414 (e.g., according to a first weight of the weighted router 408 via a weighted sampling). To illustrate, the dataset generation system 106 generates the length-based prompts 414 by incorporating the characteristics of the digital content assets according to the relationship information thereof into the length-based prompt template. For instance, the dataset generation system 106 combines the content metadata 402 with the prompt template 410 by inserting specific metadata types into fields of the prompt template according to the relationship information 404 (e.g., based on tags or identifiers of the metadata as indicated by the relationship information 404 and tags or identifiers associated with the fields).

As also depicted in FIG. 4, in one or more embodiments, the dataset generation system 106 generates the API-based prompts 416 to target different API operations. Specifically, the dataset generation system 106 combines the content metadata 402 and/or relationship information 404, with a prompt template 410 (e.g., an API-based prompt template) to generate the API-based prompts 416 (e.g., according to a second weight of the weighted router 408 via a weighted sampling). For example, the dataset generation system 106 generates the API-based prompts 416 targeting different API operations for search queries and content generation queries. To illustrate, the dataset generation system 106 generates the API-based prompts 416 by incorporating the characteristics of the digital content assets into a search API-based template or generative API-based template.

As further illustrated in FIG. 4, in one or more implementations, the dataset generation system 106 generates media-type prompts 418 including image content. In particular, the dataset generation system 106 combines the content metadata 402, relationship information 404, and/or the visual content 406 with a prompt template 410 (e.g., a media-type template) to generate the media-type prompts 418 (e.g., according to a third weight of the weighted router 408 via a weighted sampling). To illustrate, the dataset generation system 106 generates the media-type prompts 418 by incorporating the content metadata 402 and the corresponding relationship information 404 from the knowledge graph into a media-type template with images from an image repository (e.g., containing the visual content 406).

In some embodiments, the dataset generation system 106 generates the machine learning model prompts 412 to include diverse keyword positions. In these or other embodiments, the prompt templates 410 include a position condition that requires the dataset generation system 106 to place a keyword in a specific position of the machine learning model prompt generated therefrom. For instance, the prompt templates 410 include a position condition requiring that the dataset generation system 106 place a keyword at the beginning, in the middle, or at the end of a machine learning model prompt. To illustrate, based on the position condition, the dataset generation system 106 generates a machine learning model prompt with a keyword (e.g., IMAGE) at the beginning such as “IMAGE of a tiger for school project,” in the middle such as “make a tiger IMAGE for school report,” or at the end such as “I need a school report with a tiger IMAGE.”

In some implementations, the dataset generation system 106 generates synthetic heuristic prompts (or simply heuristic prompts) for training machine learning models. Specifically, the dataset generation system 106 utilizes heuristics to generate coherent sentences based on the entities of the knowledge graphs 404, the content metadata 402, the visual content 406, etc. For example, the dataset generation system 106 generates search heuristic prompts by randomly combining the related entities (e.g., intent, design type, etc.) of the knowledge graphs 404 with search synonyms (e.g., “find me,” “search for,” “look for,” “search,” “show me,” etc.).

In one or more embodiments, the dataset generation system 106 also utilizes the content metadata 402 to generate the heuristic prompts. In particular, the dataset generation system 106 generates API-based heuristic prompts for generating content by combining action verbs (e.g., “generate,” “create,” “make,” etc.) with content metadata 402 (e.g., design types and titles). Furthermore, in one or more implementations, the dataset generation system 106 expands the heuristic prompts with additional words (e.g., “please generate a template for”) followed by the content metadata 402 (e.g., the title of a digital content asset).

Additionally, in some embodiments, the dataset generation system 106 generates heuristic prompts including images (e.g., from the visual content 406). Specifically, the dataset generation system 106 generates the heuristic prompts including images for generating content from machine learning models based on the content metadata 402 associated with a digital content asset. For instance, the dataset generation system 106 generates a heuristic prompt for an image of the visual content if the metadata indicates that the image was originally generated using an artificial intelligence model.

Further, in some implementations, the dataset generation system 106 generates API-based heuristic prompts for performing a search. In particular, the dataset generation system 106 generates the API-based heuristic prompts for performing a search by combining search-related verbs (e.g., “find,” “search for,” etc.) with content descriptors (e.g., from the content metadata).

In one or more embodiments, the dataset generation system 106 also generates large language model (“LLM”)-based prompts for training machine learning models. Specifically, the dataset generation system 106 utilizes a large language model (e.g., a text-to-text large language model) to generate API prompts for performing a search and/or generating content (e.g., via a machine learning model). In one or more implementations, the dataset generation system 106 generates the LLM-based prompts by instructing the large language model to focus on one or more aspects of the content metadata (e.g., intents, assets, actions, etc.).

In some embodiments, the dataset generation system 106 utilizes the large language model to generate the LLM-based prompts for performing a search by instructing the large language model to generate a short and concise prompt. Moreover, in some implementations, the dataset generation system 106 utilizes the large language model to generate the LLM-based prompts for generating content using layout creativity and engagement as a driving factor for data generation.

In one or more embodiments, the dataset generation system 106 generates the LLM-based prompts utilizing a vision-to-text large language model. In these or other embodiments, the dataset generation system 106 instructs the vision-to-text large language model to focus on and/or emphasize the important elements unique to a template for generating the LLM-based prompts. For example, the dataset generation system 106 utilizes templates for generating the LLM-based prompts that incorporate domain-specific corpus images and visual representations of non-image content (e.g., from the visual content 406). Indeed, the dataset generation system 106 utilizes these templates for generating the LLM-based prompts including the visual content 406 to generate LLM-based prompts that capture visual aspects that are not present in the content metadata 402, leading to more natural descriptions and increased output diversity.

In one or more implementations, the dataset generation system 106 dynamically modifies the weights of the weighted router 408 utilizing a feedback loop. In particular, the dataset generation system 106 collects real-world data (e.g., user prompts to a trained machine learning model) and compares the real-world data to the machine learning model prompts 412. Based on this comparison, in some implementations, the dataset generation system 106 determines which of the prompt templates 410 result in machine learning model prompts most similar to the real-world data. In these or other embodiments, the dataset generation system 106 dynamically modifies the weights of the weighted router 408 to ensure the distribution of the machine learning model prompts 412 matches the real-world data distribution.

As just mentioned, in one or more embodiments, the dataset generation system 106 compares the real-world data to the machine learning model prompts. In particular, the dataset generation system 106 embeds the real-world user prompts in an embedding space (e.g., utilizing a trained machine learning model) and groups them in buckets based on their similarity. In these or other embodiments, the dataset generation system 106 determines whether embeddings of the machine learning model prompts 412 (e.g., in the same embedding space) sufficiently match the real-world user prompt embeddings in a given bucket. Indeed, in these or other embodiments, the dataset generation system 106 utilizes this comparison to determine which of the prompt templates 410 result in machine learning model prompts most similar to the real-world data. Additionally, in these or other embodiments, the dataset generation system 106 determines the weights of the weighted router 408 to emphasize the appropriate prompt templates 410 for generating the distribution of machine learning model prompts 412 matching the real-world data distribution.

As mentioned above, in one or more implementations, the dataset generation system 106 labels machine learning model prompts and generates a synthetic dataset. Indeed, in some embodiments, the dataset generation system 106 utilizes large language models to generate labels for the machine learning model prompts. FIG. 5 illustrates a diagram of the dataset generation system 106 utilizing large language models to generate labeled machine learning model prompts of a synthetic dataset in accordance with one or more embodiments.

As depicted in FIG. 5, in some implementations, the dataset generation system 106 generates a synthetic dataset 514 (e.g., the synthetic dataset 206 of FIG. 2) utilizing the machine learning model prompts 502 (e.g., the machine learning model prompts 412 of FIG. 4). In particular, the dataset generation system 106 generates labels for the machine learning model prompts 502 utilizing large language models (e.g., the large language model(s) 116 of FIG. 1). To illustrate, the dataset generation system 106 generates large language model prompts including the machine learning model prompts 502 and instructions for generating the labels. Furthermore, in these or other embodiments, the dataset generation system 106 utilizes the large language models to generate the labels based on the large language model prompt.

To further illustrate, the dataset generation system 106 generates labels for text prompts utilizing the text-to-text large language model 510. In one or more embodiments, a text-to-text large language model includes a large language model that takes text as input and generates text as output. Specifically, the dataset generation system 106 utilizes the text-to-text large language model to generate labels for the length-based prompts 504 (e.g., the length-based prompts 414 of FIG. 4) and/or the API-based prompts 506 (e.g., the API-based prompts 416 of FIG. 4).

To illustrate further, the dataset generation system 106 generates labels for the media-type prompts 508 (e.g., the media-type prompts 418 of FIG. 4) utilizing the vision-to-text large language model 512. In one or more implementations, a vision-to-text large language model includes a large language model that processes inputs including visual content such as images and generates a text output.

In some embodiments, the dataset generation system 106 generates the labels to indicate function classifications for the machine learning model prompts 502. For instance, the dataset generation system 106 generates the labels to indicate function classifications that classify the machine learning model prompts 502 as a search function or a generate function. To illustrate, the dataset generation system 106 generates the labels to indicate function classifications that categorize the length-based prompts 504 as search length-based prompts for prompting a machine learning model to perform a search or generative length-based prompts for prompting a machine learning model to generate content.

Similarly, in some implementations, the dataset generation system 106 generates the labels to indicate function classifications that categorize the API-based prompts 506 as search API-based prompts or generative API-based prompts. Additionally, in one or more embodiments, the dataset generation system 106 generates the labels to indicate function classifications that categorize the media-type prompts 508 as search media-type prompts or generative media-type prompts.

In one or more implementations, the dataset generation system 106 generates the labels to indicate content types targeted by the machine learning model prompts 502. In particular, the dataset generation system 106 determines a content type of the machine learning model prompts 502 by determining one or more types of media that the machine learning model prompts 502 are targeting. For example, the dataset generation system 106 determines that a content type of a machine learning model prompt 502 includes an image, a template, a video, a designer set, or other type of asset or output from a machine learning model. Further, the dataset generation system 106 generates the labels to indicate these media types.

In some embodiments, the dataset generation system 106 generates the labels to include sub-prompts. Specifically, the dataset generation system 106 utilizes the large language models (e.g., the text-to-text large language model 510 and/or the vision-to-text large language model 512) to generate labels including sub-prompts that focus on key words of the machine learning model prompts 502. For example, the dataset generation system 106 generates the sub-prompts focusing on key words of the machine learning model prompts 502 by removing unnecessary verbiage (e.g., stop words, filler words) from the machine learning model prompts 502.

As additionally shown in FIG. 5, in some implementations, the dataset generation system 106 generates the synthetic dataset 514 including labeled machine learning model prompts 516 (e.g., the labeled machine learning model prompts 208 of FIG. 2) for training machine learning models. In particular, the dataset generation system 106 generates the labeled machine learning model prompts 516 including the machine learning model prompts 502 and the labels generated for the machine learning model prompts 502 via the large language models. For example, the dataset generation system 106 associates the labels with their corresponding machine learning model prompts 502 (e.g., as part of the label generation process). Indeed, in one or more embodiments, the dataset generation system 106 generates the labeled machine learning model prompts 516 to include a set of labeled length-based prompts, a set of labeled API-based prompts, and/or a set of labeled media-type prompts.

In one or more implementations, the dataset generation system 106 trains the large language models (e.g., the text-to-text large language model 510 and the vision-to-text large language model 512) prior to generating the labels for the machine learning model prompts 502. Specifically, the dataset generation system 106 utilizes a training dataset of machine learning model prompts to generate labels utilizing the large language models. Moreover, in some embodiments, the dataset generation system 106 determines a measure of loss by comparing the generated labels with ground truth labels.

Furthermore, in some implementations, the dataset generation system 106 finetunes the large language models based on the determined measure of loss. In particular, the dataset generation system 106 finetunes the large language models by modifying the parameters thereof to reduce differences between the generated labels and the ground truth labels. Additionally, in these or other embodiments, the dataset generation system 106 utilizes the trained large language models to generate the labels for the synthetic dataset 514 based on the machine learning model prompts 502.

In one or more embodiments, the synthetic dataset 514 includes data that is not generated from real-world prompt examples. Specifically, the dataset generation system 106 generates the labeled machine learning model prompts 516 with data that is extracted from digital content assets (as described above with respect to FIG. 3) rather than from prompts submitted to machine learning models by real-world users.

In one or more implementations, the dataset generation system 106 utilizes the synthetic dataset 514 to train one or more machine learning models. In particular, the dataset generation system 106 is capable of training any type of machine learning model based on the sets of prompts included in the labeled machine learning model prompts 516. To illustrate, the dataset generation system 106 trains a machine learning model utilizing the synthetic dataset 514 to provide a plurality of different prompt types (e.g., search prompts, generative prompts, visual content prompts) to the machine learning model to prevent biasing the model's response performance. Further, in some embodiments, the dataset generation system 106 utilizes the synthetic dataset 514 in combination with other datasets to train machine learning models. For example, the dataset generation system 106 utilizes the synthetic dataset 514 in combination with the heuristic prompts and/or the LLM-based prompts (each of which is discussed above with respect to FIG. 4) to train machine learning models.

Additionally, or alternatively, the dataset generation system 106 utilizes the synthetic dataset in combination with other open-source datasets to train machine learning models. In some cases, the dataset generation system 106 improves the function and robustness of machine learning models by training the machine learning models with the synthetic dataset 514 alone or in combination with the other prompts/datasets.

In some implementations, the dataset generation system 106 trains the machine learning models with the synthetic dataset 514 utilizing low-rank adaptation (e.g., quantized low-rank adaptation). Moreover, in one or more embodiments, the dataset generation system 106 trains machine learning models utilizing four graphics processing units operating in parallel, with the base model parameters quantized to 4-bit precision while maintaining model quality through low-rank adapters. In one or more implementations, the training configuration utilizes cosine annealing for learning rate optimization with an optimizer and sets the low-rank adapter rank and alpha parameters to 16 and 32 respectively to balance adaptation capability with training stability.

Furthermore, in some embodiments, the dataset generation system 106 finetunes small language models using low-rank adaptation (e.g., quantized low-rank adaptation). For instance, the dataset generation system 106 trains the small language models utilizing four graphics processing units operating in parallel.

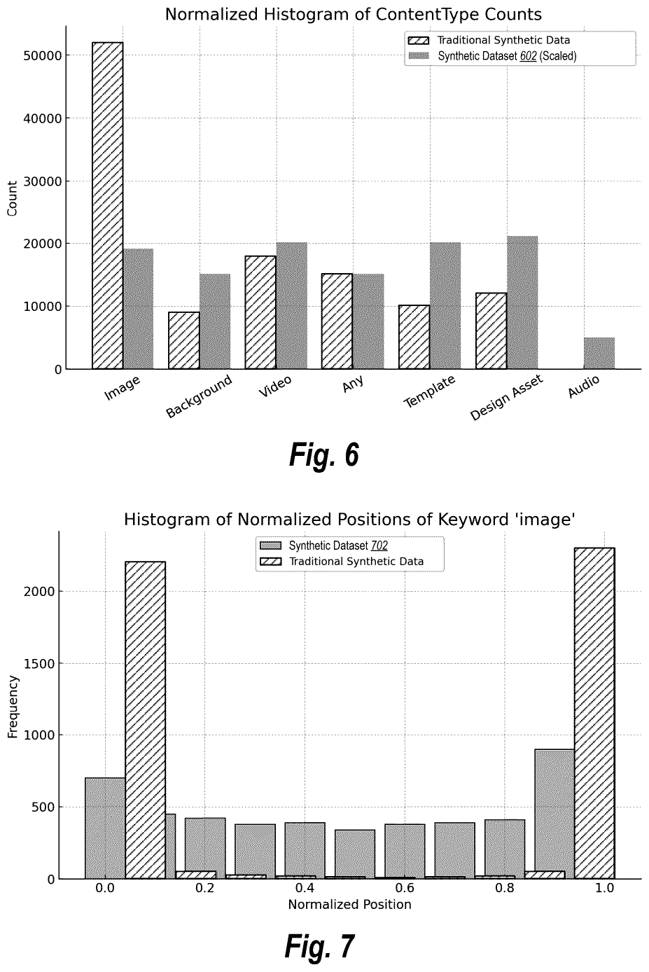

As noted above, in some implementations, the dataset generation system 106 improves the flexibility of generating different types of content within synthetic datasets for training artificial intelligence models. Indeed, in one or more embodiments, the dataset generation system 106 improves flexibility by utilizing a weighted router to generate a synthetic dataset from information extracted from digital content assets. FIG. 6 illustrates a graph of content type counts of a synthetic dataset achieved by the dataset generation system 106 compared with example prior art content type counts in accordance with one or more embodiments.

As illustrated in FIG. 6, in one or more implementations, the dataset generation system 106 uses a weighted router to achieve a relatively even distribution across multiple content types (e.g. “templates,” “images,” “videos,” “backgrounds,” etc.) in the synthetic dataset 602 (e.g., the synthetic dataset 514 of FIG. 6). Indeed, utilizing the synthetic dataset 602, the dataset generation system 106 trains machine learning models from a variety of content requests without overfitting to any single category. This balanced distribution ensures that the dataset generation system 106 exposes a machine learning model to a realistic sampling of potential queries, improving its generalization ability for content-specific API calls. In contrast, traditional synthetic data generation methods tend to be heavily skewed, with content types like “Image” dominating the dataset, while others such as “audio” and “template” are underrepresented. This can limit a model's capability to handle less frequent but important content types, resulting in suboptimal performance in real-world applications.

As mentioned previously, in some embodiments, the dataset generation system 106 improves the flexibility of generating diverse keyword positions in synthetic datasets for training artificial intelligence models. Indeed, in some implementations, the dataset generation system 106 improves flexibility by utilizing a weighted router and prompt templates to generate machine learning model prompts with diverse keyword positions. FIG. 7 illustrates a graph of keyword positions in a synthetic dataset achieved by the dataset generation system 106 compared with example prior art keyword positions in accordance with one or more embodiments.

As shown in the graph of FIG. 7, in one or more embodiments, the dataset generation system 106 generates the synthetic dataset 702 (e.g., the synthetic dataset 514 of FIG. 5) to include more even distribution of content type keywords across positions in the machine learning model prompts relative to prior art systems. By generating the synthetic dataset 702 to include even distribution of content type keywords, the dataset generation system 106 exposes machine learning models to a wider range of query (or prompt) structures, helping the machine learning models generalize and reducing overfitting. In contrast, traditional synthetic datasets often position keywords (e.g. “image,” “video,” “template,” “audio,” etc.) consistently at the beginning or end of queries. This lack of positional diversity leads to models that are prone to overfitting, as they learn to expect keywords in fixed positions, which limits their generalization capabilities in real-world scenarios.

Turning to FIG. 8, additional detail will now be provided regarding various components and capabilities of the dataset generation system 106. In particular, FIG. 8 illustrates an example schematic diagram of a computing device 800 (e.g., the server device(s) 102 and/or the client device(s) 110) implementing the dataset generation system 106 in accordance with one or more embodiments of the present disclosure for components 800-806. As illustrated in FIG. 8, the dataset generation system 106 includes a content manager 802, a weighted router 114, a prompt manager 804, large language model(s) 116, and a storage manager 806.

The content manager 802 extracts digital content asset information. For example, the content manager 802 accesses digital content assets and extracts content metadata therefrom including characteristics of the digital content assets. Additionally, the content manager 802 extracts relationship information associated with the characteristics of the digital content assets from knowledge graphs corresponding to the content metadata. Further, the content manager 802 interacts with other components to pass the content metadata and relationship information for further processing.

In one or more implementations, the prompt manager 804 receives the content metadata and relationship information and generates machine learning model prompts therefrom. Specifically, the prompt manager 804 receives the content metadata and relationship information and utilizes a weighted router to route the content metadata and relationship information to prompt templates. For instance, prompt manager 804 routes the content metadata and relationship information to the prompt templates to generate the machine learning model prompts (e.g., a first set, a second set, etc., of machine learning model prompts).

Moreover, in some embodiments, the prompt manager 804 utilizes large language models to generate labeled machine learning model prompts. In particular, the prompt manager 804 utilizes a text-to-text large language model and/or a vision-to-text large language model to generate labels for the machine learning model prompts. For example, the prompt manager 804 utilizes the large language models to generate labels indicating function classifications for the machine learning model prompts. Furthermore, in some implementations, the prompt manager generates labeled machine learning model prompts utilizing the large language model generated labels and the machine learning model prompts. Indeed, the prompt manager generates a synthetic dataset including the labeled machine learning model prompts.

Additionally, as shown in FIG. 8, the dataset generation system 106 includes a storage manager 806. In one or more implementations, the storage manager 806 stores information (e.g., via one or more memory devices) on behalf of the dataset generation system 106. For example, the storage manager 806 includes a database for storing digital content assets, knowledge graphs, content metadata, visual content, relationship information, a weighted router, prompt templates, machine learning model prompts, large language models, and/or a synthetic dataset including labeled machine learning model prompts.

In one or more embodiments, each of the components 802-806 of the dataset generation system 106 include software, hardware, or both. For example, the components 802-806 include one or more instructions stored on a computer-readable storage medium and executable by processors of one or more computing devices, such as a client device or server device. When executed by the one or more processors, the computer-executable instructions of the dataset generation system 106 cause the computing device(s) to perform the methods described herein. Alternatively, the components 802-806 include hardware, such as a special-purpose processing device to perform a certain function or group of functions. Alternatively, the components 802-806 of the dataset generation system 106 include a combination of computer-executable instructions and hardware.

Furthermore, the components 802-806 of the dataset generation system 106 are, for example, implemented as one or more operating systems, as one or more stand-alone applications, as one or more modules of an application, as one or more plug-ins, as one or more library functions or functions that may be called by other applications, and/or as a cloud-computing model. Thus, in various embodiments, the components 802-806 of the dataset generation system 106 are implemented as a stand-alone application, such as a desktop or mobile application. Furthermore, in various embodiments, the components 802-806 of the dataset generation system 106 are implemented as one or more web-based applications hosted on a remote server. Alternatively, or additionally, the components 802-806 of the dataset generation system 106 are implemented in a suite of mobile device applications or “apps.” For example, in one or more embodiments, the dataset generation system 106 comprises or operates in connection with digital software applications such as ADOBE® ACROBAT®, ADOBE® CAMERA RAW, ADOBE® PHOTOSHOP® CREATIVE CLOUD®, ADOBE® PHOTOSHOP® ELEMENTS, ADOBE® PHOTOSHOP® EXPRESS, ADOBE® PHOTOSHOP® LIGHTROOM®, ADOBE® PREMIERE® ELEMENTS, ADOBE® PREMIERE® PRO CREATIVE CLOUD®, and/or ADOBE® STOCK.

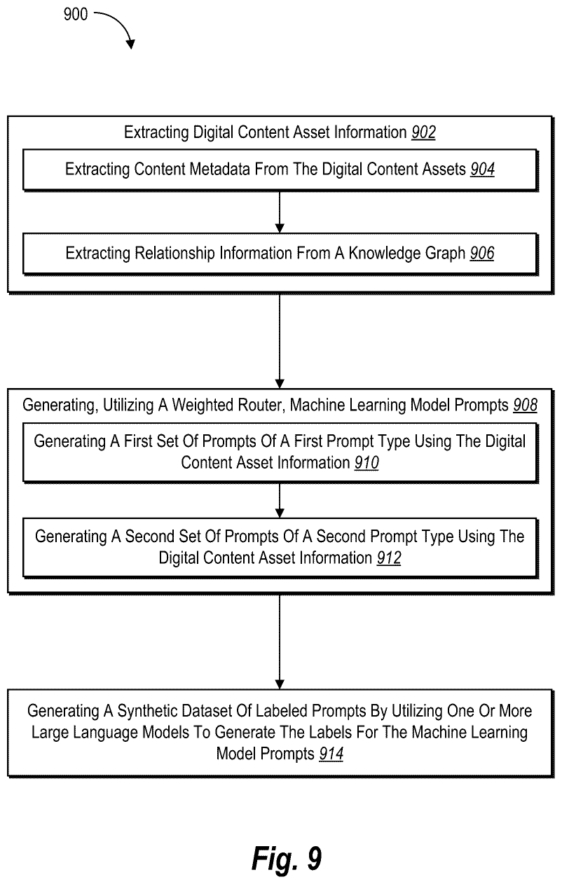

FIGS. 1-8, the corresponding text, and the examples provide a number of different systems, methods, and non-transitory computer readable media for generating a synthetic dataset for machine learning model training from digital content assets utilizing a weighted router. In addition to the foregoing, embodiments can also be described in terms of flowcharts comprising acts for accomplishing a particular result. For example, FIG. 9 illustrates a flowchart of an example sequence of acts in accordance with one or more embodiments.

While FIG. 9 illustrates acts according to some embodiments, alternative embodiments may omit, add to, reorder, and/or modify any of the acts shown in FIG. 9. The acts of FIG. 9 can be performed as part of a method. Alternatively, a non-transitory computer readable medium can comprise instructions, that when executed by one or more processors, cause a computing device to perform the acts of FIG. 9. In still further embodiments, a system can perform the acts of FIG. 9. Additionally, the acts described herein may be repeated or performed in parallel with one another or in parallel with different instances of the same or other similar acts.

FIG. 9 illustrates an example series of acts 900 for generating a synthetic dataset of labeled prompts from extracted digital content asset information utilizing a weighted router. The series of acts 900 can include an act 902 of extracting digital content asset information; an act 904 of extracting content metadata from the digital content assets; an act 906 of extracting relationship information from a knowledge graph; an act 908 of generating, utilizing a weighted router, machine learning model prompts; an act 910 of generating a first set of prompts of a first prompt type using the digital content asset information; an act 912 of generating a second set of prompts of a second prompt type using the digital content asset information; and an act 914 of generating a synthetic dataset of labeled prompts by utilizing one or more large language models to generate the labels for the machine learning model prompts.

In some embodiments, the act 904 includes extracting, by at least one processor and from digital content assets, content metadata including characteristics of the digital content assets. In some embodiments, the acts 908-912 also include an act of generating, by the at least one processor utilizing a weighted router, machine learning model prompts including a first set of prompts of a first prompt type for one or more machine learning models from the content metadata according to a first weight of the weighted router. In some implementations, the machine learning model prompts also include a second set of prompts of a second prompt type for the one or more machine learning models from the content metadata according to a second weight of the weighted router. Additionally, in one or more embodiments, the act 914 includes an act of generating a synthetic dataset including labeled prompts for training the one or more machine learning models by generating, utilizing one or more large language models, labels indicating function classifications for the machine learning model prompts.

In some implementations, generating the machine learning model prompts includes combining the content metadata with a prompt template corresponding to the first prompt type or the second prompt type to generate a machine learning prompt of the prompt type according to the first weight or the second weight of the weighted router via weighted sampling. In one or more embodiments, generating the first set of prompts of the first prompt type includes generating length-based prompts including different prompt lengths.

In one or more implementations, generating the second set of prompts of the second prompt type includes generating application programming interface (“API”)-based prompts targeting different API operations for search queries and content generation queries. In some embodiments, generating the labels indicating the function classifications for the machine learning model prompts includes generating the labels utilizing a text-to-text large language model on the first set of prompts.

In some implementations, the series of acts 900 includes determining a measure of loss by comparing the labels with ground truth labels. In one or more implementations, the series of acts 900 also includes an act of finetuning the one or more large language models by modifying parameters of the one or more large language models to reduce differences between the labels generated utilizing the one or more machine learning models and the ground truth labels. In one or more embodiments, generating the labels indicating the function classifications for the machine learning model prompts includes generating the labels to indicate the function classifications including at least one of a search function or a generate function and content types targeted by the machine learning model prompts.

In one or more implementations, the act 904 includes extracting, from digital content assets, content metadata including characteristics of the digital content assets. In some embodiments, the acts 908-912 further include an act of generating, utilizing a weighted router, machine learning model prompts including length-based prompts including different prompt lengths for a machine learning model from the content metadata according to a first weight of the weighted router. Additionally, in some implementations, the machine learning model prompts further include API-based prompts targeting different API operations for the machine learning model from the content metadata according to a second weight of the weighted router. In one or more embodiments, the act 914 also includes an act of generating a synthetic dataset including labeled prompts for training the machine learning model by generating, utilizing a text-to-text large language model, labels indicating function classifications for the machine learning model prompts.

In some embodiments, the series of acts 900 includes extracting, from a knowledge graph corresponding to the content metadata, relationship information associated with the characteristics of the digital content assets. In one or more implementations, the series of acts 900 further includes an act of wherein generating the machine learning model prompts includes generating, utilizing the weighted router, the length-based prompts and the API-based prompts from the content metadata and the relationship information from the knowledge graph.

In some implementations, the series of acts 900 includes generating the machine learning model prompts by generating the length-based prompts by routing, utilizing the weighted router, a first subset of the content metadata to one or more length-based prompt templates according to the first weight of the weighted router. Additionally, in some embodiments, the series of acts 900 includes an act of generating the API-based prompts by routing, utilizing the weighted router, a second subset of the content metadata to one or more API-based prompt templates according to the second weight of the weighted router.

In one or more embodiments, the series of acts 900 includes generating the length-based prompts by incorporating the characteristics of the digital content assets of the first subset of the content metadata into the one or more length-based prompt templates according to the first weight of the weighted router. In one or more implementations, the series of acts 900 includes generating the API-based prompts by incorporating the characteristics of the digital content assets of the second subset of the content metadata into a search API-based template or a generative API-based template of the one or more API-based prompt templates.

In some embodiments, the series of acts 900 includes generating the labels by generating, utilizing the text-to-text large language model, sub-prompts focusing on key words of the machine learning model prompts by removing unnecessary verbiage from the machine learning model prompts. In some implementations, the series of acts 900 includes generating, utilizing the weighted router, the machine learning model prompts including media-type prompts including image content utilizing the content metadata for a multimodal machine learning model according to a third weight of the weighted router.

In one or more embodiments, the act 904 includes extracting, from digital content assets, content metadata including one or more characteristics of the digital content assets. In some implementations, the act 906 also includes an act of extracting, from a knowledge graph corresponding to the content metadata, relationship information associated with the characteristics of the digital content assets. In one or more embodiments, the acts 908-912 further include an act of generating, utilizing a weighted router, machine learning model prompts including a first set of prompts of a first prompt type for one or more machine learning models utilizing the content metadata and corresponding relationship information from the knowledge graph according to a first weight of the weighted router. Additionally, in one or more implementations, the machine learning model prompts further include a second set of prompts of a second prompt type for the one or more machine learning models utilizing the content metadata and the corresponding relationship information from the knowledge graph according to a second weight of the weighted router. In some embodiments, the act 914 also includes an act of generating a synthetic dataset including labeled prompts for training the one or more machine learning models by generating, utilizing one or more large language models, labels indicating function classifications for the machine learning model prompts.

In one or more implementations, the series of acts 900 includes generating the machine learning model prompts including the first set of prompts and the second set of prompts by generating, utilizing the weighted router, text prompts including length-based prompts including different prompt lengths or API-based prompts targeting different API operations for the one or more machine learning models according to the first weight. In some implementations, the series of acts 900 further includes an act of generating, utilizing the weighted router, media-type prompts including image content for the one or more machine learning models according to the second weight.

In some embodiments, the series of acts 900 includes generating media-type prompts including image content by incorporating the content metadata and the corresponding relationship information from the knowledge graph into a media-type template with images from an image repository. In some implementations, the series of acts 900 includes generating the labels utilizing a vision-to-text large language model on the first set of prompts and a text-to-text large language model on the second set of prompts.

In one or more embodiments, generating the labels includes determining, utilizing the one or more large language models, a content type of the machine learning model prompts indicating that the machine learning model prompts are targeting one or more types of media. In one or more implementations, the series of acts 900 includes generating the labels indicating the function classifications for the machine learning model prompts as search API-based prompts or generative API-based prompts.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media. Non-transitory computer-readable storage media (devices) includes optical and/or non-optical memory, disks, or caches that store computer data interpretable by one or more processors to execute particular functions as described herein. A “network” is defined as one or more data links that enable the transport of electronic data between computer systems and/or modules and/or other electronic devices. Information is transferred or provided over a network (either hardwired, wireless, or a combination of hardwired or wireless) to a computer to carry program code in the form of computer-executable instructions or data structures and which can be accessed by a general purpose or special purpose computer.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code.

Embodiments of the present disclosure can also be implemented in cloud computing environments. In this description, “cloud computing” is defined as a model for enabling on-demand network access to a shared pool of configurable computing resources. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth.

FIG. 10 illustrates, in block diagram form, an example computing device 1000 (e.g., the computing device 800, the client device(s) 110, and/or the server device(s) 102) that may be configured to perform one or more of the processes described above. As shown by FIG. 10, the computing device can comprise a processor(s) 1002, memory 1004, a storage device 1006, an I/O interface 1008, and a communication interface 1010.

In particular embodiments, processor(s) 1002 includes hardware for executing instructions, such as those making up a computer program. As an example, and not by way of limitation, to execute instructions, processor(s) 1002 may retrieve (or fetch) the instructions from an internal register, an internal cache, memory 1004, or a storage device 1006 and decode and execute them. The computing device 1000 includes memory 1004, which is coupled to the processor(s) 1002. The memory 1004 may be used for storing data, metadata, and programs for execution by the processor(s). The memory 1004 may include one or more of volatile and non-volatile memories. The memory 1004 may be internal or distributed memory. The computing device 1000 includes a storage device 1006 includes storage for storing data or instructions. As an example, and not by way of limitation, storage device 1006 can comprise a non-transitory storage medium described above. The computing device 1000 also includes one or more input or output (“I/O”) devices/interfaces 1008, which are provided to allow a user to provide input to (such as user strokes), receive output from, and otherwise transfer data to and from the computing device 1000. These I/O devices/interfaces 1008 may include a mouse, keypad or a keyboard, a touch screen, camera, optical scanner, network interface, modem, other known I/O devices or a combination of such I/O devices/interfaces 1008.

The computing device 1000 can further include a communication interface 1010. The communication interface 1010 can include hardware, software, or both. The communication interface 1010 can provide one or more interfaces for communication (such as, for example, packet-based communication) between the computing device and one or more other computing devices (e.g., computing device 1000) or one or more networks. The computing device 1000 can further include a bus 1012. The bus 1012 can comprise hardware, software, or both that couples components of computing device 1000 to each other.

What is claimed is:

1. A computer-implemented method comprising:
extracting, by at least one processor and from digital content assets, content metadata comprising characteristics of the digital content assets;
generating, by the at least one processor utilizing a weighted router, machine learning model prompts comprising:
a first set of prompts of a first prompt type for one or more machine learning models from the content metadata according to a first weight of the weighted router; and
a second set of prompts of a second prompt type for the one or more machine learning models from the content metadata according to a second weight of the weighted router; and
generating a synthetic dataset comprising labeled prompts for training the one or more machine learning models by generating, utilizing one or more large language models, labels indicating function classifications for the machine learning model prompts.

2. The computer-implemented method of claim 1, wherein generating the machine learning model prompts comprises combining the content metadata with a prompt template corresponding to the first prompt type or the second prompt type to generate a machine learning prompt of the prompt type according to the first weight or the second weight of the weighted router via weighted sampling.

3. The computer-implemented method of claim 1, wherein generating the first set of prompts of the first prompt type comprises generating length-based prompts including different prompt lengths.

4. The computer-implemented method of claim 1, wherein generating the second set of prompts of the second prompt type comprises generating application programming interface (“API”)-based prompts targeting different API operations for search queries and content generation queries.

5. The computer-implemented method of claim 1, wherein generating the labels indicating the function classifications for the machine learning model prompts comprises generating the labels utilizing a text-to-text large language model on the first set of prompts.

6. The computer-implemented method of claim 1, further comprising:
determining a measure of loss by comparing the labels with ground truth labels; and
finetuning the one or more large language models by modifying parameters of the one or more large language models to reduce differences between the labels generated utilizing the one or more machine learning models and the ground truth labels.

7. The computer-implemented method of claim 1, wherein generating the labels indicating the function classifications for the machine learning model prompts comprises generating the labels to indicate the function classifications comprising at least one of a search function or a generate function and content types targeted by the machine learning model prompts.

8. A system comprising:
one or more memory devices; and
one or more processing devices configured to cause the system to:
extract, from digital content assets, content metadata comprising characteristics of the digital content assets;
generate, utilizing a weighted router, machine learning model prompts comprising:
length-based prompts including different prompt lengths for a machine learning model from the content metadata according to a first weight of the weighted router; and
API-based prompts targeting different API operations for the machine learning model from the content metadata according to a second weight of the weighted router; and
generate a synthetic dataset comprising labeled prompts for training the machine learning model by generating, utilizing a text-to-text large language model, labels indicating function classifications for the machine learning model prompts.

9. The system of claim 8, wherein the one or more processing devices are further configured to:
extracting, from a knowledge graph corresponding to the content metadata, relationship information associated with the characteristics of the digital content assets; and
wherein generating the machine learning model prompts comprises generating, utilizing the weighted router, the length-based prompts and the API-based prompts from the content metadata and the relationship information from the knowledge graph.

10. The system of claim 8, wherein the one or more processing devices are further configured to generate the machine learning model prompts by:
generating the length-based prompts by routing, utilizing the weighted router, a first subset of the content metadata to one or more length-based prompt templates according to the first weight of the weighted router; and
generating the API-based prompts by routing, utilizing the weighted router, a second subset of the content metadata to one or more API-based prompt templates according to the second weight of the weighted router.

11. The system of claim 10, wherein the one or more processing devices are further configured to generate the length-based prompts by incorporating the characteristics of the digital content assets of the first subset of the content metadata into the one or more length-based prompt templates according to the first weight of the weighted router.

12. The system of claim 10, wherein the one or more processing devices are further configured to generate the API-based prompts by incorporating the characteristics of the digital content assets of the second subset of the content metadata into a search API-based template or a generative API-based template of the one or more API-based prompt templates.

13. The system of claim 8, wherein the one or more processing devices are further configured to generate the labels by generating, utilizing the text-to-text large language model, sub-prompts focusing on key words of the machine learning model prompts by removing unnecessary verbiage from the machine learning model prompts.

14. The system of claim 8, wherein the one or more processing devices are further configured to generate, utilizing the weighted router, the machine learning model prompts comprising media-type prompts comprising image content utilizing the content metadata for a multimodal machine learning model according to a third weight of the weighted router.

15. A non-transitory computer readable medium storing executable instructions which, when executed by a processing device, cause the processing device to perform operations comprising:
extracting, from digital content assets, content metadata comprising one or more characteristics of the digital content assets;
extracting, from a knowledge graph corresponding to the content metadata, relationship information associated with the characteristics of the digital content assets;
generating, utilizing a weighted router, machine learning model prompts comprising:
a first set of prompts of a first prompt type for one or more machine learning models utilizing the content metadata and corresponding relationship information from the knowledge graph according to a first weight of the weighted router; and
a second set of prompts of a second prompt type for the one or more machine learning models utilizing the content metadata and the corresponding relationship information from the knowledge graph according to a second weight of the weighted router; and
generating a synthetic dataset comprising labeled prompts for training the one or more machine learning models by generating, utilizing one or more large language models, labels indicating function classifications for the machine learning model prompts.

16. The non-transitory computer readable medium of claim 15, wherein the instructions further cause the processing device to generate the machine learning model prompts comprising the first set of prompts and the second set of prompts by:
generating, utilizing the weighted router, text prompts including length-based prompts including different prompt lengths or API-based prompts targeting different API operations for the one or more machine learning models according to the first weight; and
generating, utilizing the weighted router, media-type prompts comprising image content for the one or more machine learning models according to the second weight.

17. The non-transitory computer readable medium of claim 15, wherein the instructions further cause the processing device to generate media-type prompts comprising image content by incorporating the content metadata and the corresponding relationship information from the knowledge graph into a media-type template with images from an image repository.

18. The non-transitory computer readable medium of claim 15, wherein the instructions further cause the processing device to generate the labels utilizing a vision-to-text large language model on the first set of prompts and a text-to-text large language model on the second set of prompts.

19. The non-transitory computer readable medium of claim 15, wherein generating the labels comprises determining, utilizing the one or more large language models, a content type of the machine learning model prompts indicating that the machine learning model prompts are targeting one or more types of media.

20. The non-transitory computer readable medium of claim 15, wherein the instructions further cause the processing device to generate the labels indicating the function classifications for the machine learning model prompts as search API-based prompts or generative API-based prompts.
